(19) United States
(12) Patent Application Publication
(10) Pub. No.: US 2010/0198733 A1
(43) Pub. Date: Aug. 5, 2010

(54) Enabling Payment Using Paperless Image Of A Check

(75) Inventors: Alexander Gantman, Poway, CA (US); Gregory Gordon Rose, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/637,525

(22) Filed: Dec. 14, 2009

Related U.S. Application Data
(60) Provisional application No. 61/149,958, filed on Feb. 4, 2009.

(51) Int. Cl. G06Q 20/00; G06Q 40/00; H04L 9/32

(52) U.S. Cl. 705/75; 705/39; 705/44; 705/64

(57) ABSTRACT

Payment or financial transactions are facilitated between two parties by utilizing mobile devices. A payor's mobile device may be adapted to generate an electronic/paperless version or image of a check. The payor may make the paperless image of a check out to a particular payee so that it can be cashed from the payor's checking account. The electronically-generated check may be in the form of an image than can be transmitted by the payor's mobile device to the recipient's mobile device. The payee then submits the received check, electronically or in paper form, to a financial institution for redemption.

### CLAIM OF PRIORITY UNDER 35 U.S.C.§119

The present Application for Patent claims priority to U.S. Provisional Application No. 61/149958 entitled “Check-Based Person-To-Person Mobile Payment”, filed Feb. 4, 2009, assigned to the assignee hereof and hereby expressly incorporated by reference herein.

### BACKGROUND

1. Field

One feature relates to facilitating the ease of transferring funds between two mobile devices and, more specifically, to transferring funds by rendering a paperless image of a check in a payor mobile device and transmitting the paperless image of the check to a payee recipient device for subsequent fulfillment of the check.

2. Background

As more financial transactions are performed electronically, there is a need for facilitating transactions without the need for currency or cash. Additionally, it is often cumbersome to carry a wallet or purse with a checkbook, credit cards, cash cards, or currency. However, most people carry a mobile phone or communication device. Therefore, it would be advantageous to provide a way to utilize a mobile phone or communication device to conduct transactions between two parties while avoiding the need for physical cash currency, credit cards, or checkbooks.

### SUMMARY

Payment or financial transactions are facilitated between two parties by utilizing a paperless image of a check.

According to one aspect, a method operational on a payor device and/or processing device is provided. Sufficient information to render an image of a check is obtained. The sufficient information may include, for example, a payor bank account number, a recipient name, an amount, and a payor signature. A paperless image of a check is rendered by the payor device. The paperless image of the check may be rendered through an application operating in the payor device. The paperless image of the check may be a digital image resembling a paper check which may serve as legal tender for a transaction.

The paperless image of the check is then transmitted to a recipient device. The paperless image of the check may be stored as an electronic file and the electronic file may be transmitted to the recipient device. A payor seeking to render the paperless image of the check may be authenticated prior to transmitting the paperless image of the check to the recipient device. The transmission of the paperless image of the check may be secured by using a cryptographic key. The transmission of the paperless image of the check to the recipient device may be a wireless transmission. The wireless transmission may be a point-to-point transmission from the payor device and the recipient device.

In various implementations, the payor device may be a mobile device that is associated with a payor and/or a network server that generates the paperless image on behalf of a payor. In one implementation, the recipient device may be a mobile communication device that is associated with a payee. In another implementation, the recipient device may be a server for a financial institution and the paperless image of the check is transmitted to a wireless network access node that transmits the paperless image of the check to the server.

Subsequently, the payer device may receive confirmation from the recipient device that the paperless image of the check has been correctly received. To further secure the paperless image of the check, an authentication code may be generated for authenticating the paperless image of the check. The authentication code may then be included as part of the paperless image of the check. The authentication code may include at least one of a payor bank account number, a recipient name, an amount, or a check number, signed by a private code known to a corresponding payor and a payor financial institution. The authentication code may allow a payor financial institution to ascertain the accuracy of information appearing on the paperless image of the check.

According to another aspect, a method operational on a payee recipient device or processing device is provided. A paperless image of a check may be received from a payor device. One of either the paperless image of the check or a paper version of the check may then be submitted to a financial institution for payment. A security protocol may be performed between the payor device and the recipient device to secure reception of the paperless image of the check. Prior to receiving the paperless image of the check, the recipient device may send a request for payment to the payor device. A confirmation may be sent to the payor device that the paperless image of the check has been correctly received. The paperless image of the check may be stored for subsequent submission and/or the paperless image of the check may be printed prior to submission. The paperless image of the check may be a digital image resembling a paper check and/or may serve as legal tender for a transaction. The paperless image of the check may include a payor bank account number, a recipient name, an amount, and a payor signature. The payee recipient device may receive the paperless image of a check from a payor device via a point-to-point wireless transmission. In various implementations, the payee recipient device may be a mobile communication device and/or a server for a financial institution.

### BRIEF DESCRIPTION OF THE DRAWINGS

FIG. 1 is a block diagram illustrating an example in which a payor can use a mobile device to provide a paperless image of a check to a payee.

FIG. 2 is a block diagram illustrating another example in which a payor can use a mobile device to provide a paperless image of a check to a payee.

FIG. 3 is a block diagram illustrating yet another example in which a payor can use a mobile device to provide a paperless image of check to an institutional recipient.

FIG. 4 is a block diagram illustrating yet another example in which a payor can use a mobile device to make payment with a paperless image of a check.

FIG. 5 is a block diagram illustrating an example of a mobile device.

FIG. 6 illustrates a method operational in a payor mobile device for payment using an electronic/paperless image of a check.

FIG. 7 is a block diagram illustrating an example of a recipient device.

FIG. 8 illustrates a method operational on a payee recipient device for receiving an electronic/paperless image of a check.

FIG. 9 is a block diagram illustrating various network environment situations in which the payment by check image may be implemented.

FIG. 10 illustrates a method between a payor device and a payee device to perform a transaction using an electronic or paperless image of a check.

FIG. 11 illustrates an example of a paperless image of a check.

### DETAILED DESCRIPTION

In the following description, specific details are given to provide a thorough understanding of the embodiments. However, it will be understood by one of ordinary skill in the art that the embodiments may be practiced without these specific details. For example, circuits may be shown in block diagrams, or not be shown at all, in order not to obscure the embodiments in unnecessary detail. In other instances, well-known circuits, structures and techniques may not be shown in detail in order not to obscure the embodiments.

In the following description, certain terminology is used to describe certain features. The term “mobile device” includes, but is not limited to, a mobile phone, a mobile communication device, personal digital assistant, mobile palm-held computer, a wireless device, and/or other types of mobile devices typically carried by individuals and/or having some form of communication capabilities (e.g., wireless, infrared, short-range radio, etc.). The term “payor device”, “payee device” and/or “processing device” may include a mobile device, personal computing device, a digital assistant device, a laptop computer, a point-of-sale device, etc. The term “payor” refers to a person, entity, and/or device making payment to a payee. The term “payee” refers to a person, entity, and/or device that receives the payment from the payor. For example, the payee may be one to which the payor makes payment in fulfillment of a debt, obligation, or to transaction. The term “paperless image of a check” refers to an electronic rendering resembling a traditional paper check but which originates in digital form not paper form. That is, “paperless image of a check” looks like a traditional paper check but is initially issued by the payor in a digital or electronic form (e.g., a graphic format or electronic/digital rendering).

A method is provided for facilitating payment or financial transactions between two people by utilizing their mobile devices. In one example, a payor's mobile device may be adapted to generate an electronic/paperless version or image of a check. The payor may make the paperless image of a check out to a particular payee so that it can be cashed from the payor's checking account. In one instance, the electronically-generated check may be in the form of an image than can be transmitted by the payor's mobile device to the recipient's mobile device. The payee may then submit the received check, electronically or in paper form, to a financial institution to obtain payment. Note that the payor may send an electronic image or paperless copy of an actual check (from the payor's checkbook) which the payee can then cash or deposit.

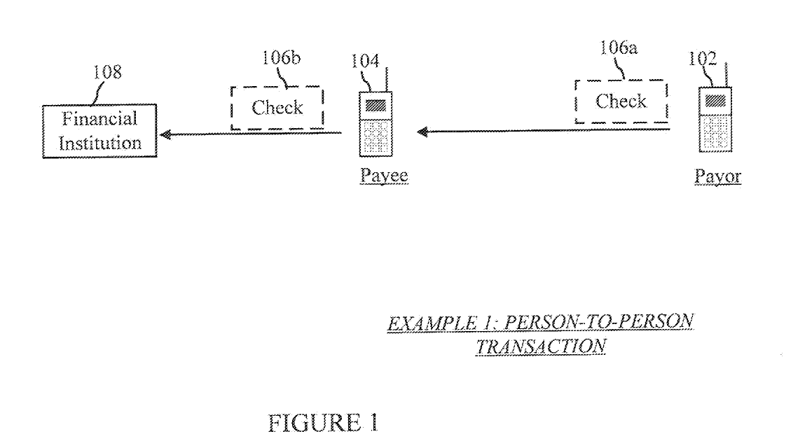

FIG. 1 is a block diagram illustrating an example in which a payor can use a mobile device to provide a paperless image of a check to a payee. The payor can generate an electronic image of a check 106a from a payor mobile device 102. The electronic image of the check 106a is then sent (e.g., electronic transmission, wirelessly, via email, Multimedia Messaging Service (MMS), etc.) to a payee mobile device 104. The payee can then present the electronic image of the check 106b to a financial institution 108 for cashing the check.

In one example, payor wants to pay payee a certain amount. Using a payment application executing on payor's mobile device 102, payor selects payee from a mobile device contact list, enters the amount, and hits ‘send’. The payment application in payor's mobile device 102 generates an image of a traditional paper check with payor's bank account information (e.g., routing number, account information, etc.), payee's name, and the amount being paid and sends (e.g., wirelessly, electronic mail, via MMS, etc.) the image of the check to payee's mobile device 104. If payee's bank participates in this form of paperless check payment, then payee mobile device 104 simply forwards the MMS to his bank for deposit. If not, payee can print out the image of the check in plain paper (e.g., to produce a paper version of the check) and deposits it like a regular check. Note that, in the U.S., the Check Clearing for the 21st Century Act (also known as “Check 21”) makes a printed copy of an image the legal equivalent of the original check (with some caveats).

In some implementations, the payment application may first authenticate the payor to verify that, in fact, it is the actual/authorized payor (and not someone else) who is making the payment. For example, this may prevent unauthorized parties from fraudulently issuing payment from the payor's mobile device.

Additionally, to prevent interception of the image of the check during wireless transmission, the payor and payee may exchange keys (e.g., public/private key cryptography) or use other security mechanism to prevent or inhibit an unauthorized party from accessing the image of the check during transmission. For example, the payor may encrypt the image of the check with a public key for the payee prior to transmission. Thus, only the payee should be able to access the encrypted image of the check by using its associated private key.

Other implementation choices are possible to improve security and/or better fit into existing payment frameworks. In one example, the payment transaction may be performed with an automated clearing house (ACH) that processes the paperless image of the check and generates an equivalent e-check, two-dimensional (2D) bar code of a PIN-based key-Hash Message Authentication Code (HMAC), international payments via local proxies, etc., for fulfillment of a transaction to a payee.

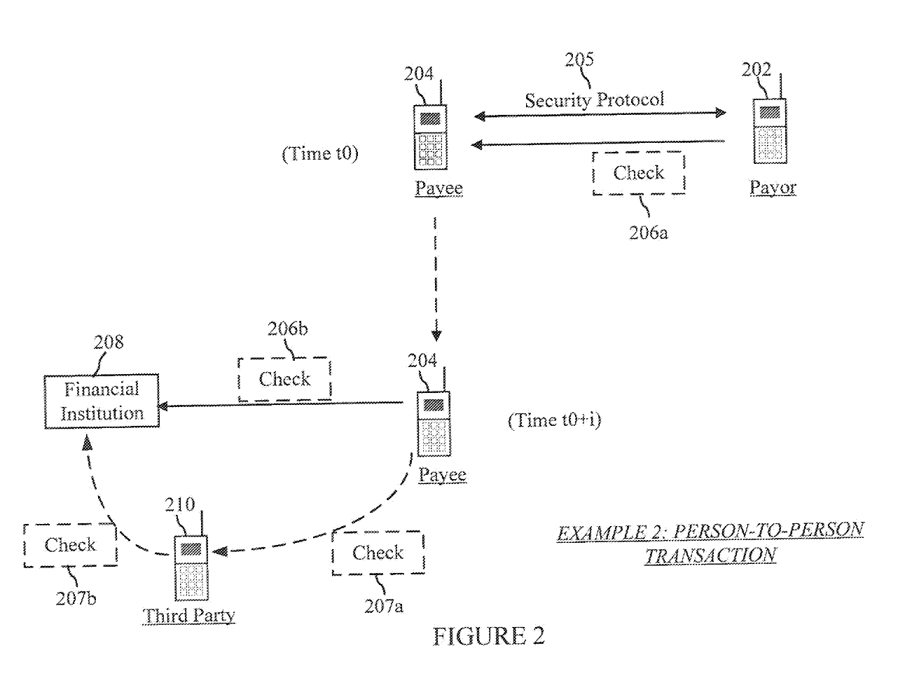

FIG. 2 is a block diagram illustrating another example in which a payor can use a mobile device to provide a paperless image of a check to a payee. In many instances, the payor and payee may not have a trust relationship. So, there is the risk that a check may be modified by the payee prior to being deposited (e.g., in order to defraud the payor). Consequently, the payor's mobile device 202 and/or payee's mobile device 204 may first execute a security protocol 205 in which security keys and/or authentication information may be exchanged. This security protocol 205 may serve, for example, to authenticate the payor and/or payee to each other, to establish a key that can be used to secure the electronic/paperless image of the check 206, and/or to prevent a third party (aside from the intended payee) from cashing the check 206. The payor's mobile device 202 then generates an electronic/paperless image of a check 206a and may protect it according to the security mechanism established with the payee. The electronic image of the check 206a is then sent (e.g., wirelessly, via email, Multimedia Messaging Service (MMS), etc.) to the payee's mobile device 204. In one embodiment, upon receiving the electronic image of the check 206a, the payee mobile device 204 may store it for later submission or fulfillment by a financial institution. Note that, in some implementations, the electronic/paperless image of the check 206a may be sent to an email account associated with the payee. In such case, the payee may receive payment on any device capable of accessing such email account (not just a payee mobile device).

At a later time (t0+i), the payee can present the electronic image of the check 206b to a financial institution 208 for cashing the check. The financial institution 208 may be the payee's bank, the payor's bank, or any other clearing house or entity that facilitates processing of such image of the check.

In yet other instances, the electronic image of the check 206b may be used by the payee to pay a third party recipient rather than cashing it at the financial institution 208. Consequently, a payment application operating on the payee's mobile device 204 may be capable of endorsing the electronic image of the check 206b to the third party recipient and transmitting the re-endorsed image of the check 207a to the third party mobile device 210. The third party mobile device 210 may then present the re-endorsed image of the check 207b to a financial institution 208.

In yet other examples, this payment system may be used by a payor to perform financial transactions with institutions, such as, pay for utility bills, pay for groceries, pay for food at a restaurant, give out donations, etc. The payor uses the payment application operating in the payor's mobile device to send or submit an electronic image of a check to a particular institution which can then deposit it or cash it.

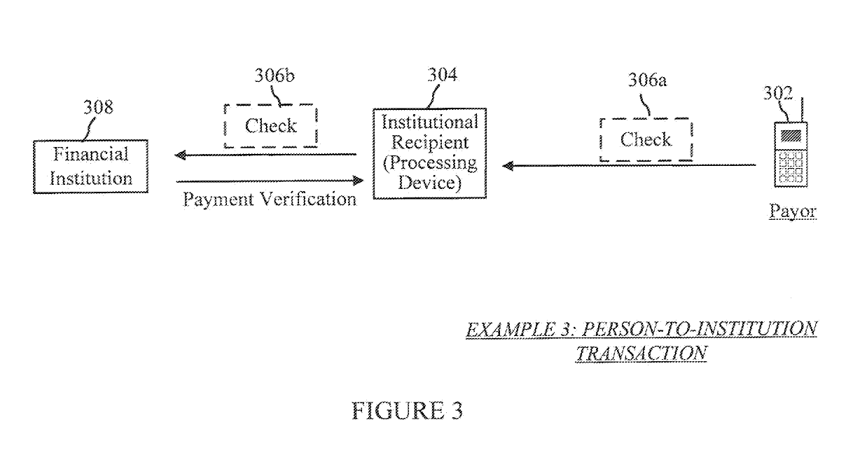

FIG. 3 is a block diagram illustrating yet another example in which a payor can use a mobile device to provide a paperless image of a check to an institutional recipient. The payor may utilize a payment application on a payor mobile device 302 to generate an electronic/paperless image of a check 306a that is endorsed to an institutional recipient 304 (e.g., utility company, grocery store, restaurant, church, school, etc.). In this example, the electronic image of the check 306a may be sent to a processing device (e.g., server, point-of-payment, an account number, etc.) that receives and processes checks for the institutional recipient 304. The electronic image of the check 306b may be sent (wirelessly, via email, via Multimedia Messaging Service (MMS), etc.) to the institutional recipient's processing device 304.

In one example, the institutional recipient processing device 304 can present the electronic/paperless image of the check 306b to a financial institution 308 or processing center. In this example, the transaction may be performed electronically and the financial institution 308 can provide real-time or near real-time payment verification to the submitting institutional recipient processing device 304.

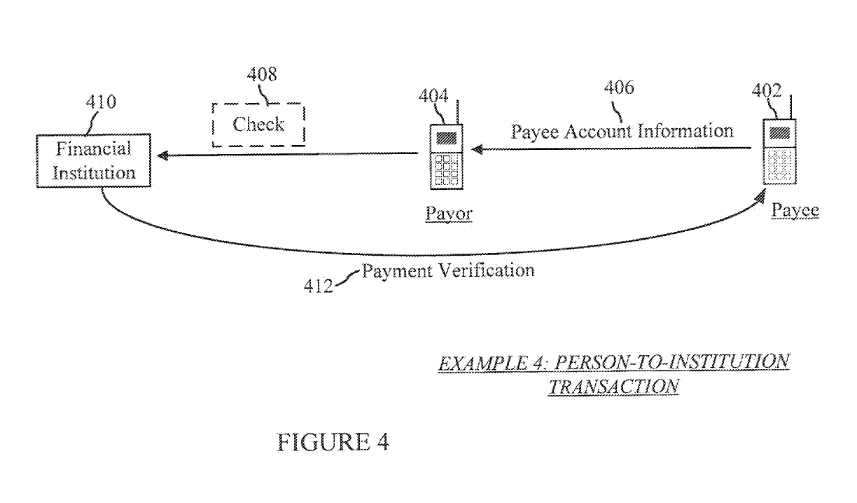

FIG. 4 is a block diagram illustrating yet another example in which a payor can use a mobile device to make payment with a paperless image of a check. In this implementation, as part of a transaction, the payee mobile device 402 may send its payment account information 406 to the payor mobile device 404. The payor mobile device 404 may then generate a paperless image of a check payable to the payee and sends it to a financial institution 410 along with the payee account information. The financial institution 410 may process the paperless image of the check and deposits it in the payee's account. The financial institution 410 may determine that the payee's check is valid (e.g., that the funds are available) and sends a payment verification message 412 to the payee. Therefore, the payee can receive verification of the payor's check from the financial institution 410.

There are several advantages to performing a transaction using an electronic/paperless image of a check as illustrated in FIGS. 1-4. First, from the point-of-view of a recipient or payee, there are no pre-requisites to receiving payment. Only a mobile device (or any recipient device) or an electronic mail (email) account is needed to receive an electronic or paperless image of a check. This system does not need any special applications operating on the recipient/payee mobile device. Additionally, no bank participation is required, although it may be helpful for a smoother user experience and/or fulfillment of a transaction. Second, this payment approach also provides a value proposition for carriers (e.g., providers of wireless service to the mobile devices) that helps drive messaging traffic when the paperless image of the check is send over a messaging service provided carriers. Third, the use of a mobile device (e.g., mobile phone, FDA, etc.) to render and transmit the paperless image of a check is convenient and familiar to a generation of users that grew up using mobile devices and messaging applications. Fourth, the use of checks leverages an existing payment framework, without need for a new payment infrastructure/protocol.

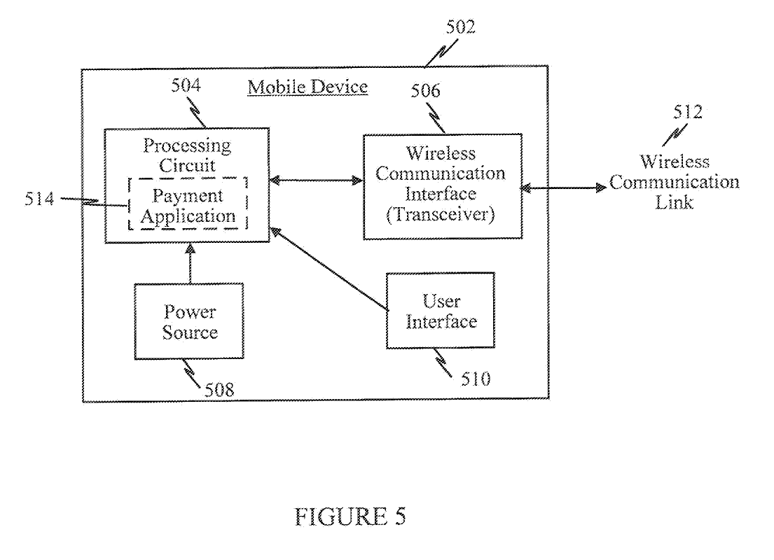

FIG. 5 is a block diagram illustrating an example of a mobile device. The mobile device 502 may include a processing circuit 504 coupled to a wireless communication interface 506, an internal power source 508, a user interface 510. The processing circuit 504 may execute a payment application 514. The user of the mobile device 502 may use the payment application 514 to generate a paperless image of a check and sends it to another device via the wireless communication interface 506 through a wireless communication link 512. The user interface 510 (e.g., key pad, display, etc.) may enable the user (e.g., payor) to provide information to the payment application to generate the paperless image of the check. In one example, the processing circuit 504 may be adapted to (a) obtain sufficient information to render an image of a check, (b) render a paperless image of a check on the mobile device, and/or (c) transmit the paperless image of the check to a recipient device.

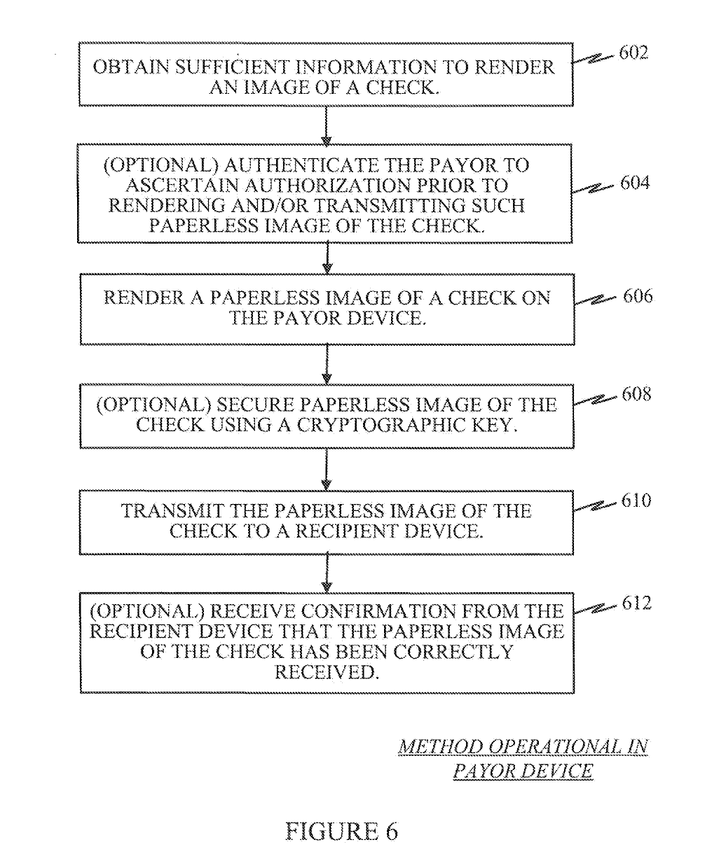

FIG. 6 illustrates a method operational in a payor device for payment using an electronic/paperless image of a check. The payor device obtains sufficient information to render an image of a check 602. For instance, the sufficient information may include a payor bank account number, a recipient name, an amount, and a payor signature. The recipient (e.g., payee) name and the amount may be obtained as part of a transaction. The payor bank account number and payor signature may be pre-stored in the payor device. The payor device may then render (e.g., generate, create, produce, and/or obtain) a paperless image of a check on the payor device 606. The paperless image of the check may be rendered through an application operating in the payor device. The paperless image of the check may be rendered as a digital image resembling a paper check and/or may serve as legal tender for a transaction. In an alternative implementation, rendering of the paperless image of the check is performed by an external network server on behalf of the payor or payor device.

The payor device may then transmit the paperless image of the check to a recipient device 610. For instance, such transmission may be performed over email, messaging services, or other communication services. In one example, the paperless image of the check may be stored as an electronic file and the electronic file is transmitted to the recipient device. Prior to such transmission, the payor may be authenticated by the payor device to ascertain that it is authorized to render and/or transmit such paperless image of the check 604. The transmission of the paperless image of the check may also be secured by using a cryptographic key 608. For instance, the payor device and the recipient device may have performed a key exchange to generate a key with which the payor device can encrypt or otherwise secure the paperless image of the check. This prevents or inhibits an unauthorized party from intercepting transmission of the paperless image of the check, cashing the check, and/or otherwise obtaining other information from the paperless image of the check (e.g., account information, etc.).

The transmission of the paperless image of the check to the recipient device may be a wireless transmission. The wireless transmission may be a point-to-point transmission from the payor device and the recipient device.

In response to the transmission, the payor device may receive confirmation from the recipient device that the paperless image of the check has been correctly received 612. In one example, the recipient device may be a mobile communication device that is associated with a payee. In another example, the recipient device may be a server for a financial institution and the paperless image of the check is transmitted to a wireless network access node that transmits the paperless image of the check to the server.

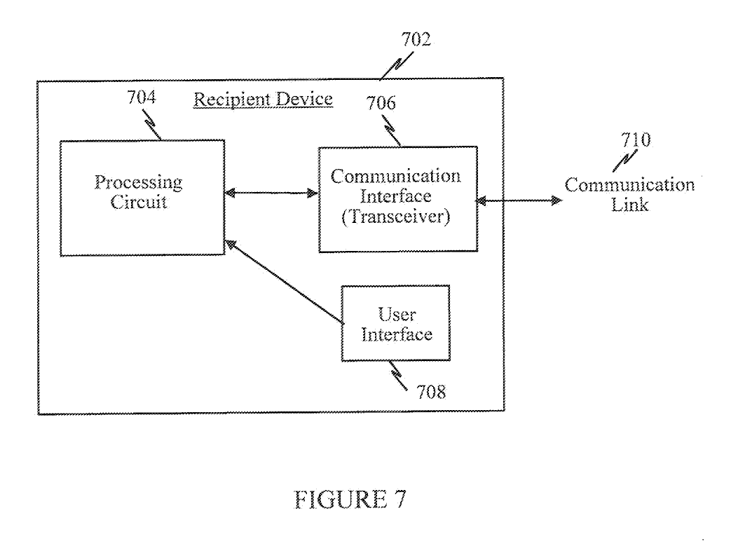

FIG. 7 is a block diagram illustrating an example of a recipient device. In various implementations, the recipient device may be a mobile device, a computer, and/or a server. The recipient device 702 may include a processing circuit 704 coupled to a communication interface 706, and a user interface 708. In one implementation, the recipient device 702 may be a mobile device that is able to receive a paperless image of a check from a payor via a communication link 710. The recipient device 702 may then forward the paperless image of the check to a financial institution (e.g., bank) for fulfillment. Such communication link 710 may be over a wired or wireless medium. In another implementation, the recipient device 702 may be a computer or server capable of receiving, storing, and/or processing a paperless image of a check from a payor on behalf a payee. For example, the recipient device 702 may be a mail server capable of receiving an email containing paperless image of the check or it may be a bank server capable of receiving and processing an image of a check on behalf of a payee. The user interface 708 (e.g., key pad, display, etc.) may enable the user (e.g., payee) to process the received paperless image of the check. In one example, the processing circuit 704 may be adapted to (a) receive a paperless image of a check from a payor mobile device, (b) submit one of either the paperless image of the check or a paper version of the check to a financial institution for payment, and/or (c) send confirmation to the payor mobile device that the paperless image of the check has been correctly received.

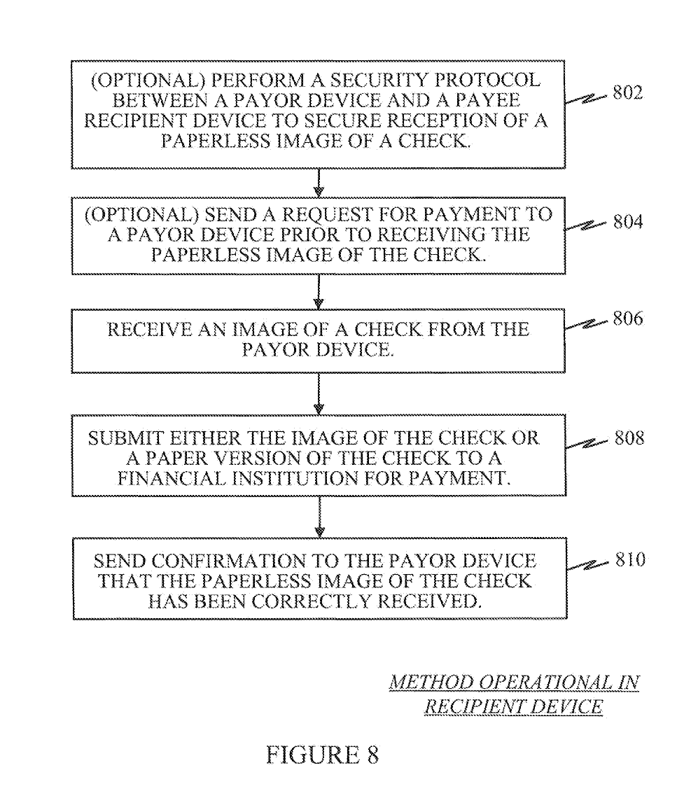

FIG. 8 illustrates a method operational on a payee recipient device for receiving an electronic/paperless image of a check. Optionally, a security protocol may be performed between a payor mobile device and the payee recipient device to secure reception of a paperless image of a check 802. Optionally, the payee recipient device may send a request for payment to the payor mobile device prior to receiving the paperless image of the check 804. In response, the payee recipient device may receive a paperless image of a check from the payor mobile device 806. The paperless image of the check may include a payor bank account number, a recipient name, an amount, and a payor signature. The paperless image of the check may be a digital image resembling a paper check and serves as legal tender for a transaction.

The payee recipient device may subsequently submit either the paperless image of the check or a paper version of the check to a financial institution for payment 808. Additionally, the payee recipient device may send confirmation to the payor mobile device that the paperless image of the check has been correctly received 810. In some implementations, the payee recipient device may store the paperless image of the check for subsequent submission and/or may print the paperless image of the check prior to submission. In one example, the payee recipient device is a mobile communication device. In another example, the payee recipient device is a server for a financial institution. The payee recipient device may receive the paperless image of a check from a payor mobile device via a point-to-point wireless transmission.

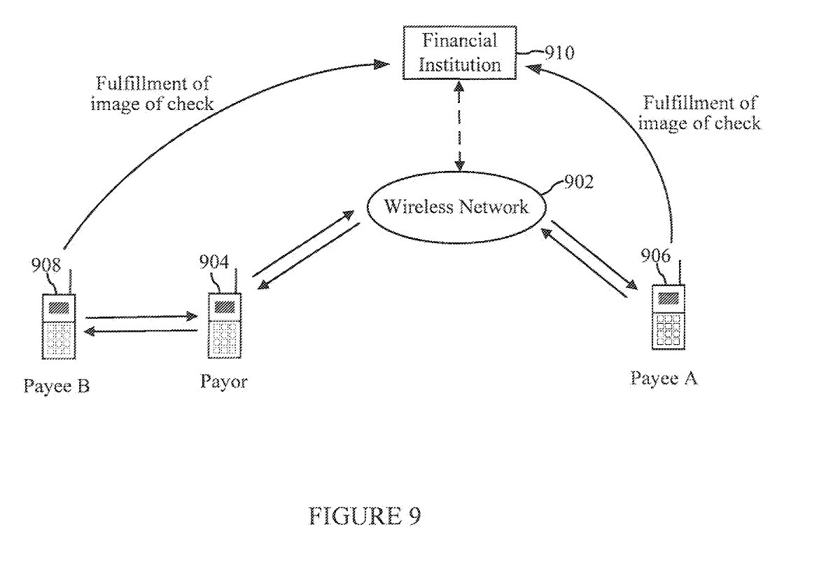

FIG. 9 is a block diagram illustrating various network environment situations in which the payment by check image may be implemented. For instance, a payor mobile device 904 (Payor) may send payment to a first recipient mobile device 906 (Payee A) via a wireless network 902. Alternatively, the payor mobile device 904 (Payor) may send payment to a second recipient mobile device 908 (Payee B) via a direct link (e.g., infrared, etc.). The recipient mobile devices 906 or 908 may submit the image of the check via the wireless network 902 or by directly depositing it (e.g., as a paper copy).

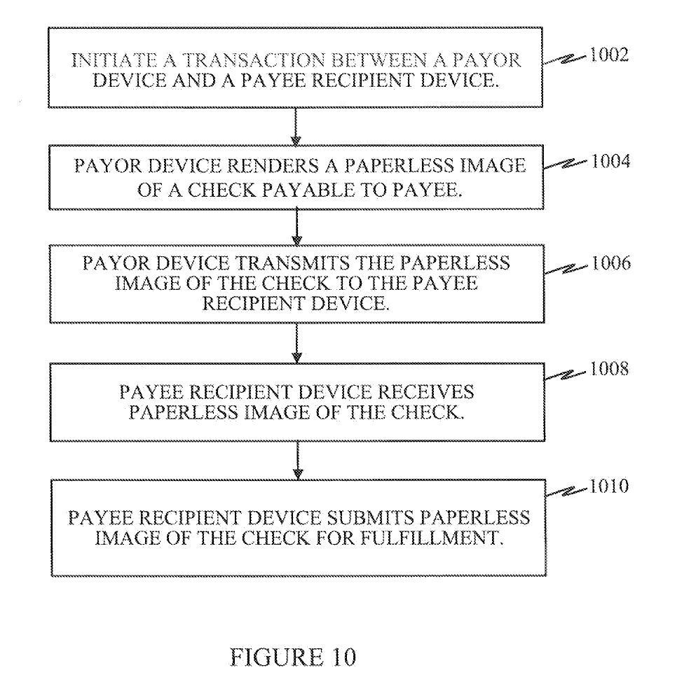

FIG. 10 illustrates a method between a payor device and a payee device to perform a transaction using an electronic or paperless image of a check. A transaction (e.g., commercial transaction, purchase/sale, etc.) may be initiated between a payor device and a payee recipient device 1002. The payor device renders a paperless image of a check payable to a payee 1004. The payor device then transmits the paperless image of the check to the payee recipient device 1006. The payee recipient device receives the paperless image of the check 1008 and submits it to a financial institution for fulfillment 1010 (e.g., to cash it). It should be noted that the paperless image of the check being used in the transaction is not merely an electronic payment but rather a paperless image of a traditional check. Therefore, the paperless image of the check can be used as a direct replacement for a traditional check. In an alternative implementation, a network server may render the paperless image of the check on behalf of the payor and/or payor device and transmits it to the payee recipient device.

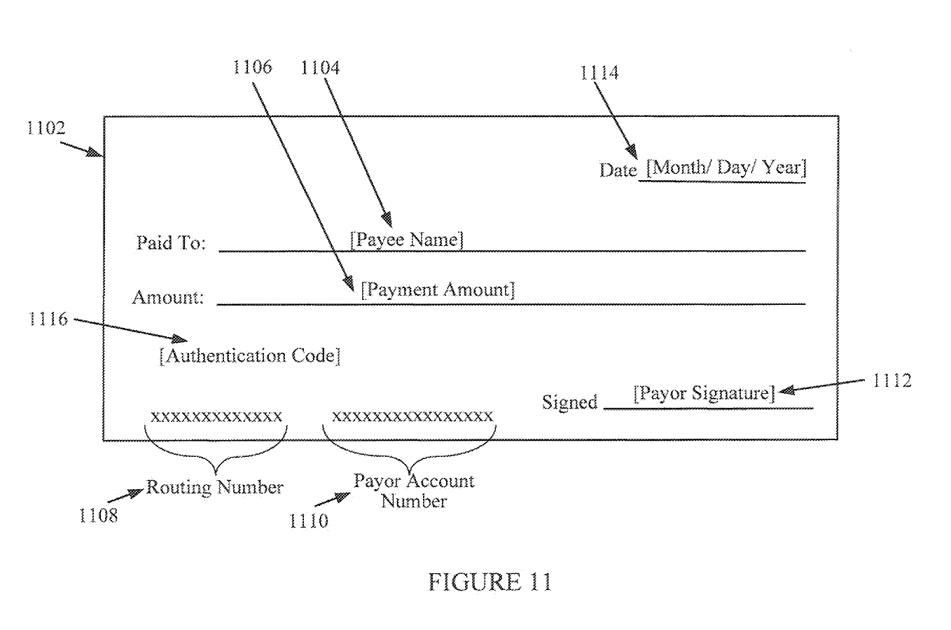

FIG. 11 illustrates an example of a paperless image of a check. The paperless image of a check 1102 may initially be rendered electronically, not on paper. The paperless image of the check 1102 may include a Payee Name 1104, a Payment Amount 1106, a Payor Bank Routing Number 1108, a Payor Account Number 1110, a Payor Signature 1112, and/or an issuance date. In other examples, the paperless image of the check may include additional information or less information.

According to yet another feature, digital authentication of a check may also be implemented. Just as with paper checks, a paperless image of the check may be susceptible to tampering and/or forging (e.g., to modify the amount or payee, to forge multiple checks, etc.). To address this problem, digital authentication (e.g., Key-Hashed Message Authentication. Code (HMAC)) of the paperless image of the check may be implemented. For example, since the payor and payor's financial institution (e.g., payor's bank) have a pre-established relationship, this may permit authentication of the paperless image of the check when presented to the payor's financial institution. For instance, the payor and payor's financial institution may both know a password or code (e.g., used for bank card transactions) associated with the payor or payor's account. Therefore, in one example, an authentication code 1116 is generated and included as part of the paperless image of the check 1102. The authentication code may be generated so that it allows detecting whether a paperless image of a check has been tampered with and/or forged. In one example, the authentication code may include the payment amount, the payee name, the payor account number, a check number, payment date, and/or routing number, all of which may be signed by a private or secret code known only to the payer and/or the payor's financial institution.

Upon receipt of a paperless image of a check for redemption at the payor's financial institution, the financial institution can verify the information on the check (e.g., payment amount, payee name, payor account number, check number, payment date, routing number, etc.) against the signed authentication code. That is, the payor's financial institution can generate a version of the authentication code and compare it to the received authentication code in the paperless image of the check. Thus, if a paperless image of a check has been tampered with or forged (e.g., payee name, the payer account number, a check number, payment date, and/or routing number are modified), then the payor's financial institution can ascertain this if its version of the authentication code does not match the authentication code in the paperless image of the check.

In various examples, the authentication code in the paperless image of the check may be a number, an alpha-numeric string, and/or a bar code. Also note that, when a check-generating application is used to generate the paperless image of the check, such application may be configured with the payor's private or secret code to automatically generate the authentication code and include it as part of the paperless image of the check.

The various illustrative logical blocks, modules and circuits and algorithm steps described herein may be implemented or performed as electronic hardware, software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. It is noted that the configurations may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

When implemented in hardware, various examples may employ a general purpose processor, a digital signal processor (DSP), an application specific integrated circuit (ASIC), a field programmable gate array signal (FPGA) or other programmable logic device, discrete gate or transistor logic, discrete hardware components or any combination thereof designed to perform the functions described herein. A general purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core or any other such configuration.

When implemented in software, various examples may employ firmware, middleware or microcode. The program code or code segments to perform the necessary tasks may be stored in a computer-readable medium or processor-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the terms “component,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In one or more examples herein, the functions described may be implemented in hardware, software, firmware, or any combination thereof. If implemented in software, the functions may be stored on or transmitted over as one or more instructions or code on a computer-readable medium or processor-readable medium. A processor-readable media and/or computer-readable media include both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium or processor-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. Software may comprise a single instruction, or many instructions, and may be distributed over several different code segments, among different programs and across multiple storage media. An exemplary storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is required for proper operation of the embodiment that is being described, the order and/or use of specific steps and/or actions may be modified without departing from the scope of the claims.

One or more of the components, steps, and/or functions illustrated in the Figures may be rearranged and/or combined into a single component, step, or function or embodied in several components, steps, or functions. Additional elements, components, steps, and/or functions may also be added without departing from the invention. The novel algorithms described herein may be efficiently implemented in software and/or embedded hardware.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method operational on a payor device, comprising:
obtaining sufficient information to render an image of a check;
rendering a paperless image of a check at the payor device; and
transmitting the paperless image of the check to a recipient device.

2. The method of claim 1, wherein the sufficient information includes a payor bank account number, a recipient name, an amount, and a payor signature.

3. The method of claim 1, wherein the paperless image of the check is rendered through an application operating in the payor device.

4. The method of claim 1, wherein the paperless image of the check is rendered as a digital image resembling a paper check.

5. The method of claim 1, further comprising:
storing the paperless image of the check as an electronic file; and
transmitting the electronic file to the recipient device.

6. The method of claim 1, further comprising:
authenticating a payor seeking to render the paperless image of the check prior to transmitting the paperless image of the check to the recipient device.

7. The method of claim 1, further comprising:
securing the transmission of the paperless image of the check by using a cryptographic key.

8. The method of claim 1, further comprising:
receiving confirmation from the recipient device that the paperless image of the check has been correctly received.

9. The method of claim 1, wherein the payor device is a mobile device that is associated with a payor.

10. The method of claim 1, wherein payor device is a network server that generates the paperless image on behalf of a payor.

11. The method of claim 1, wherein the transmission of the paperless image of the check to the recipient device is a wireless transmission.

12. The method of claim 11, wherein the wireless transmission is a point-to-point transmission from the payor device and the recipient device.

13. The method of claim 1, wherein the recipient device is a mobile communication device that is associated with a payee.

14. The method of claim 1, wherein the recipient device is a server for a financial institution and the paperless image of the check is transmitted to a wireless network access node that transmits the paperless image of the check to the server.

15. The method of claim 1, wherein the paperless image of the check serves as legal tender for a transaction.

16. The method of claim 1, further comprising:
generating an authentication code for authenticating the paperless image of the check; and
including the authentication code as part of the paperless image of the check.

17. The method of claim 16, wherein the authentication code includes at least one of a payor bank account number, a recipient name, an amount, or a check number, signed by a private code known to a corresponding payor and a payor financial institution.

18. The method of claim 16, wherein the authentication code allows a payor financial institution to ascertain accuracy of information appearing on the paperless image of the check.

19. A processing device, comprising:
a wireless communication interface; and
a processing circuit coupled to the wireless communication interface, the processing circuit adapted to:
obtain sufficient information to render an image of a check;
render a paperless image of a check at the processing device; and
transmit the paperless image of the check to a recipient device.

20. The processing device of claim 19, wherein the paperless image of the check is rendered through an application operating in the processing device.

21. The processing device of claim 19, wherein the paperless image of the check is rendered as a digital image resembling a paper check.

22. The processing device of claim 19, wherein the paperless image of the check serves as legal tender for a transaction.

23. The processing device of claim 19, wherein the processing circuit is further adapted to:
authenticate a payor seeking to render the paperless image of the check prior to transmitting the paperless image of the check to the recipient device; and
secure the transmission of the paperless image of the check by using a cryptographic key.

14. A processing device, comprising:
means for obtaining sufficient information to render an image of a check;
means for rendering a paperless image of a check at the processing device; and
means for transmitting the paperless image of the check to a recipient device.

25. A processor-readable medium comprising instructions operational in a processing device for making payment with an image of a check, which when executed by a processor causes the processor to:
obtain sufficient information to generate an image of a check;
generate an image of a check at the payor device; and
send the image of the check to a recipient device.

26. A method operational on a payee recipient device, comprising:
receiving a paperless image of a check from a payor device; and
submitting one of either the paperless image of the check or a paper version of the check to a financial institution for payment.

27. The method of claim 26, further comprising:
performing a security protocol between the payor device and the recipient device to secure reception of the paperless image of the check.

28. The method of claim 26, further comprising:
sending a request for payment to the payor device prior to receiving the paperless image of the check.

29. The method of claim 26, further comprising:
sending confirmation to the payor device that the paperless image of the check has been correctly received.

30. The method of claim 26, further comprising:
storing the paperless image of the check for subsequent submission.

31. The method of claim 26, further comprising:
printing the paperless image of the check prior to submission.

32. The method of claim 26, wherein the paperless image of the check is a digital image resembling a paper check.

33. The method of claim 26, wherein the paperless image of the check serves as legal tender for a transaction.

34. The method of claim 26, wherein the paperless image of the check includes a payor bank account number, a recipient name, an amount, and a payor signature.

35. The method of claim 26, wherein the payee recipient device receives the paperless image of a check from a payor device via a point-to-point wireless transmission.

36. The method of claim 26, wherein the payee recipient device is a mobile communication device.

37. The method of claim 26, wherein the payee recipient device is a server for a financial institution.

38. A processing device, comprising:
a wireless communication interface; and
a processing circuit coupled to the wireless communication interface, the processing circuit adapted to:
receive a paperless image of a check from a payor device; and
submit one of either the paperless image of the check or a paper version of the check to a financial institution for payment.

39. A processing device, comprising:
means for receiving a paperless image of a check from a payor device; and
means for submitting one of either the paperless image of the check or a paper version of the check to a financial institution for payment.

40. A processor-readable medium comprising instructions operational on a payee recipient device for receiving payment in the form of an image of a check, which when executed by a processor causes the processor to:
receive a paperless image of a check from a payor device; and
submit one of either the paperless image of the check or a paper version of the check to a financial institution for payment.
